(19) United States
(12) Patent Application Publication
(10) Pub. No.: US 2024/0267258 A1
(43) Pub. Date: Aug. 8, 2024

(54) COMMUNICATION DEVICE, COMMUNICATION METHOD, AND PROGRAM

(71) Applicant: NIPPON TELEGRAPH AND TELEPHONE CORPORATION, Tokyo (JP)

(72) Inventors: Tomoya KOSUGI, Tokyo (JP); Shinichi YOSHIHARA, Tokyo (JP); Akihiro MORITA, Tokyo (JP)

(73) Assignee: NIPPON TELEGRAPH AND TELEPHONE CORPORATION, Tokyo (JP)

(21) Appl. No.: 18/566,634

(22) PCT Filed: Jun. 4, 2021
(86) PCT No.: PCT/JP2021/021431

§ 371 Date: Dec. 2, 2023

(51) Int. Cl. H04L 12/46; H04L 45/28

(52) U.S. Cl. CPC H04L 12/4641; H04L 45/28

(57) ABSTRACT

A communication device (10) according to the present disclosure includes a selection list creation unit (12) that creates a selection list including identifiers and Weight reference values of a plurality of communication devices configuring Multihoming based on the identifiers of the plurality of communication devices configuring the Multihoming and the Weight reference value according to a communication state of each of the plurality of communication devices configuring the Multihoming notified of by another device, and a selection unit (13) that selects a designated forwarder (DF) and a backup DF (BDF) from the created selection list based on a predetermined condition based on the Weight reference value.

### TECHNICAL FIELD

The present disclosure relates to a communication device, a communication method, and a program.

### BACKGROUND ART

One technique for implementing a Layer 2 Virtual Private Network (L2VPN) is an Ethernet Virtual Private Network (EVPN) described in Non Patent Literature 1.

In the EVPN, traffic of customers is distinguished by an EVPN Instance (EVI) in a communication network of a communication company, so that an L2VPN service can be provided for each customer. In addition, in Non Patent Literature 1, EVPM Multihoming (simply referred to hereinafter as “Multihoming”) in which a plurality of provider edges (PEs) are connected to one customer edge (CE) is defined for the purpose of improving the availability of a PE that is a communication device of a company connected to the CE that is a communication device of a customer.

In Non Patent Literature 1, in Multihoming, an Ethernet segment (ES) is defined for a link in which a PE and a CE are connected. In a case where there is a plurality of PEs having the same ES Identifier (ESI) as an identifier for identifying an ES in a communication network of a communication carrier, it indicates that the plurality of PEs is connected to the same CE.

In Non Patent Literature 1, one PE is selected as a designated forwarder (DF) in units of ESI, only the DE forwards Broadcast, Unknown unicast, Multicast (BUM) traffic to the CE, and another PE (non-DF) does not forward (drop) the BUM traffic to the CE. In this way, even if one CE is connected to a plurality of PEs, the occurrence of a broadcast storm (loop failure) is prevented. Further, in Non Patent Literature 2, when a failure occurs in a DE, a non-DF that will be a new DF is defined as a backup DE (BDF).

Next, a DF selection algorithm (Service Carving) described in Non Patent Literature 1 and Non Patent Literature 2 will be described.

In a case where ESI is set in the host device, the PE conforming to Non Patent Literature 1 sets Layer 2 VPN (25) in the address family identifier of the multi-protocol border gateway protocol (MP-BGP), sets EVPN (4) in the subsequence address family identifier, sets Ethernet Segment Route (4) in the route type of the network layer reachability information field, describes the ESI set in the host device, the IP address set in the host device, and the like, and transmits the results to the communication network.

In a case where the ESI set in the host device and the ESI notified of by the MP-BGP EVPN route type 4 are the same and an IP address of a new PE belonging to the ESI is found, the PE connected to the communication network starts to select a DF. Specifically, the PE waits for notification of the MP-BGP EVPN route type 4 from another PE in the communication network for a predetermined time (Discovery Timer). After the discovery timer ends, the PE creates a list of IP addresses for each ESI. The PE creates a list by arranging the IP addresses of the plurality of PEs belonging to the ESI in ascending order with the IP address of the smallest PE being 0. Next, the PE acquires a remainder i obtained by dividing the EVI having the smallest value among the EVIs belonging to the ES by the number of PEs participating in the ES (modulo operation), and selects the i-th PE in the created list as the DF.

In addition, Non Patent Literature 2 describes a method for selecting a DF and a BDF. In this selection method, Weight is calculated using an ESI, an Ethernet Tag (an identifier used to identify a plurality of bridge domains (BDs) present in an EVI in a VLAN-Aware Bundle Service Interface, which is one of three service instances defined in Non Patent Literature 1), the IP address of a PE, and the like as variables of a random function or the like. Then, the PE having the smallest weight is selected as the DF, and the PE having the second smallest weight is selected as the BDF.

### CITATION LIST

### Non Patent Literature

Non Patent Literature 1: RFC7432 “BGP MPLS-Based Ethernet VPN”
Non Patent Literature 2: RFC8584 “Framework for Ethernet VPN Designated Forwarder Election Extensibility”

### SUMMARY OF INVENTION

### Technical Problem

Since the selection methods described in Non Patent Literature 1 and Non Patent Literature 2 use the set value of the PE in the communication network, there is a problem that the DF and the BDF cannot be flexibly selected according to a communication state such as a band or a delay. For example, in the selection methods described in Non Patent Literature 1 and Non Patent Literature 2, the bandwidth is concentrated on the PE selected as the DF, congestion may occur, and a PE having a large delay with respect to a certain CE may be selected as the DF.

An object of the present disclosure made in view of the above problems is to provide a communication device, a communication method, and a program capable of flexibly selecting a DF and a BDF according to a communication state.

### Solution to Problem

In order to solve the above problem, a communication device according to the present disclosure is a communication device that configures Multihoming in which a plurality of communication devices is connected to one customer network device and is connected to a communication network, the communication device including a selection list creation unit that creates a selection list including identifiers and Weight reference values of a plurality of communication devices configuring the Multihoming based on the identifiers of the plurality of communication devices configuring the Multihoming and the Weight reference value according to a communication state of each of the plurality of communication devices configuring the Multihoming notified of by another device, and a selection unit that selects, from the created selection list, a designated forwarder (DF) that forwards traffic to the customer network device and a backup DF (BDF) that will become a new DF when a failure occurs in the DF, based on a predetermined condition based on the Weight reference value.

In order to solve the above problem, the communication device according to the present disclosure is a communication device that is connected to a plurality of communication devices configuring Multihoming for one customer network device via a communication network and does not configure the Multihoming, the communication device including a notification unit configured to notify each of a plurality of communication devices configuring the Multihoming of identifiers of the plurality of communication devices configuring the Multihoming and a Weight reference value according to a communication state of each of the plurality of communication devices configuring the Multihoming.

In addition, in order to solve the above problem, a communication method according to the present disclosure is a communication method by a communication device that configures Multihoming in which a plurality of communication devices is connected to one customer network device and is connected to a communication network, the communication method including creating a selection list including identifiers and Weight reference values of a plurality of communication devices configuring the Multihoming based on the identifiers of the plurality of communication devices configuring the Multihoming and the Weight reference value according to a communication state of each of the plurality of communication devices configuring the Multihoming notified of by another device, and selecting, from the created selection list, a designated forwarder (DF) that forwards traffic to the customer network device and a backup DF (BDF) that will become a new DF when a failure occurs in the DE, based on a predetermined condition based on the Weight reference value.

Furthermore, in order to solve the above problems, a program according to the present disclosure causes a computer to function as the communication device described above.

### Advantageous Effects of Invention

According to the communication device, the communication method, and the program according to the present disclosure, a DF and a BDF can be flexibly selected according to a communication state.

### BRIEF DESCRIPTION OF DRAWINGS

FIG. 1 is a diagram illustrating a configuration example of a communication system according to an embodiment of the present disclosure.

FIG. 2 is a diagram illustrating an example of an operation of a PE illustrated in FIG. 1.

FIG. 3 is a diagram illustrating an example of a selection list created by a selection list creation unit illustrated in FIG. 1.

FIG. 4 is a diagram illustrating another configuration example of a communication system according to the embodiment of the present disclosure.

FIG. 5 is a diagram illustrating an example of operation of a PE illustrated in FIG. 4.

FIG. 6 is a diagram illustrating an example of a Weight reference value list created by a Weight reference value list creation unit illustrated in FIG. 4.

FIG. 7 is a diagram illustrating an example of a Weight reference value matrix created by a selection list creation unit illustrated in FIG. 4.

FIG. 8 is a diagram illustrating an example of selection of a DF and a BDF by the selection unit illustrated in FIG. 4.

FIG. 9 is a diagram illustrating another example of selection of a DF and a BDF by the selection unit illustrated in FIG. 4.

FIG. 10 is a diagram illustrating still another configuration example of the communication system according to the embodiment of the present disclosure.

FIG. 11 is a diagram illustrating another configuration example of a PE 10a illustrated in FIG. 4.

FIG. 12 is a diagram illustrating another configuration example of the PE 10 illustrated in FIG. 4.

FIG. 13 is a diagram illustrating an example of a hardware configuration of the PE 10 illustrated in FIG. 1.

### DESCRIPTION OF EMBODIMENTS

Hereinafter, embodiments of the present disclosure will be described with reference to the drawings.

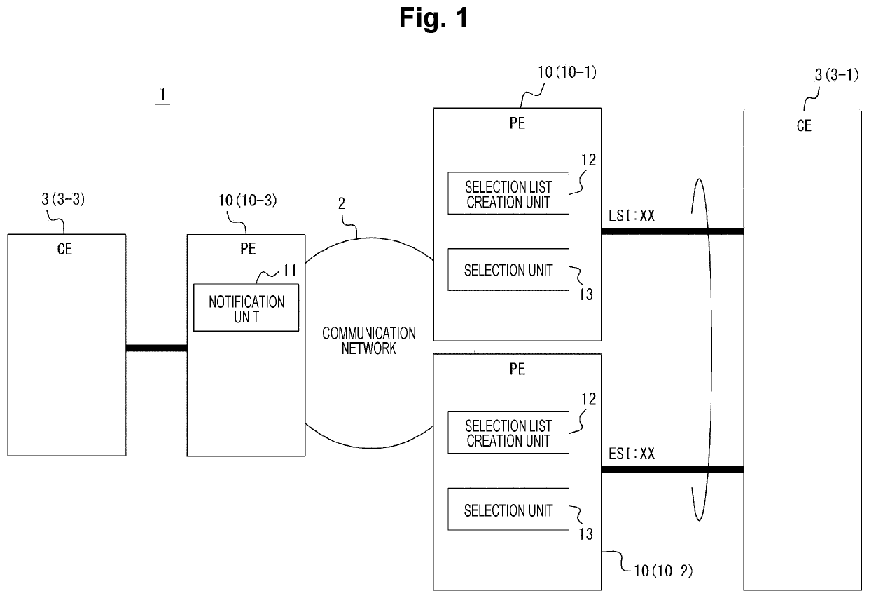

FIG. 1 is a diagram illustrating a configuration example of a communication system 1 according to an embodiment of the present disclosure. As illustrated in FIG. 1, the communication system 1 according to the present embodiment includes a plurality of provider edges (PEs) 10-1, 10-2, and 10-3 connected to a communication network 2. Hereinafter, when the PEs 10-1, 10-2, and 10-3 are not distinguished, they are referred to as a PE 10.

The PE 10 is a communication device of a communication carrier provided in an edge region of the communication network 2. The PE 10 is connected to a customer edge (CE) 3 which is a communication device (customer network device) of a customer via a link. In the example illustrated in FIG. 1, the PE 10-1 and the PE 10-2 are connected to one CE 3-1. The same ESI: XX is set for the link between the PE 10-1 and the CE 3-1 and the link between the PE 10-2 and the CE 3-1. Therefore, the PE 10-1 and the PE 10-2 configure the Multihoming for the CE 3-1. That is, the PEs 10-1 and 10-2 configure the Multihoming in which a plurality of PEs 10 are connected to the CE 3-1 (one customer network device), and are communication devices connected to the communication network 2. The PEs 10-1 and 10-2 select a designated forwarder (DF) that transfers the BUM traffic to the CE 3-1 and a backup DF (BDF) that will newly become a DF when a failure occurs in the DF from the plurality of PEs 10 configuring the Multihoming for the CE 3-1. Note that, in the present disclosure, the “link” includes a physical link and a virtual link such as link aggregation or a virtual local area network (VLAN), and is not limited to a specific technology.

The PE 10-3 is connected to a CE 3-3. That is, the PE 10-3 is a communication device that is connected to the CE 3-3 different from the CE 3-1 (a customer network device different from one customer network device) and does not configure the Multihoming for the CE 3-1. In addition, the PE 10-3 is a communication device that is connected to a plurality of PEs 10-1 and 10-2 configuring the Multihoming for the CE 3-1 (one customer network device) via the communication network 2 and does not configure the Multihoming.

Note that FIG. 1 illustrates an example in which the number of PEs 10 configuring the Multihoming is two for simplification of description, but the present invention is not limited thereto, and the number of PEs 10 configuring the Multihoming may be three or more. In addition, FIG. 1 illustrates an example in which one CE 3 is connected to each PE 10 via the link, but the present invention is not limited thereto, and two or more CEs 3 may be connected to one PE 10.

Next, the configurations of the PE 10-1 and the PE 10-3 will be described. Since the configuration of the PE 10-2 is the same as the configuration of the PE 10-1, the description thereof will be omitted. First, the configuration of the PE 10-3 will be described.

As illustrated in FIG. 1, the PE 10-3 includes a notification unit 11.

The notification unit 11 notifies the PEs 10-1 and 10-2 of the identifiers (for example, an IP address set in each PE 10) of the PEs 10-1 and 10-2, which are a plurality of communication devices configuring the Multihoming, and the Weight reference values of the PEs 10-1 and 10-2, respectively. The Weight reference value is a value corresponding to information (hereinafter, referred to as “network information”) regarding the communication state (for example, a delay, a band, the number of hops in the communication network 2, a metric of a routing protocol, a priority, and the like) of the PE 10.

Next, the configuration of the PE 10-1 will be described.

As illustrated in FIG. 1, the PE 10-1 includes a selection list creation unit 12 and a selection unit 13.

The selection list creation unit 12 creates the selection list based on the identifiers of the plurality of PEs 10 configuring the Multihoming and each of the Weight reference values of the plurality of PEs 10 configuring the Multihoming notified of by another device. The selection list is a list including identifiers and Weight reference values of each of the plurality of PEs 10 configuring the Multihoming, and is used to select the DF and the BDF. As described above, the PE 10-3 notifies of the identifiers and the Weight reference values of the PEs 10-1 and 10-2. Therefore, in FIG. 1, the other device is a PE 10-3 that is connected to a CE 3-1 (one customer network device) different from the CE 3-3 and does not configure Multihoming for the CE 3-1.

The selection unit 13 selects the DF and the BDF based on a predetermined condition from the selection list created by the selection list creation unit 12.

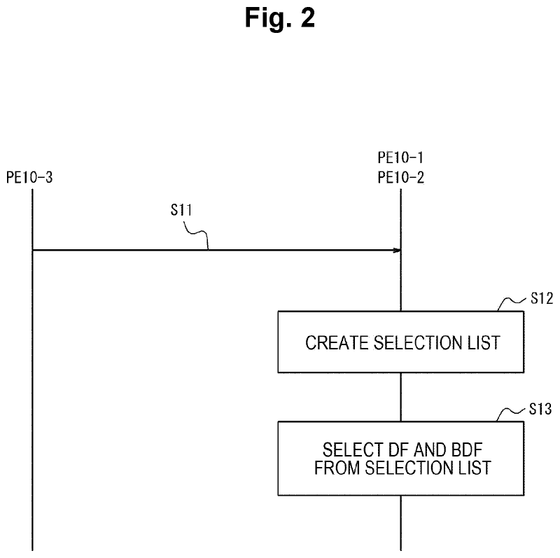

Next, operations of the PEs 10-1 to 10-3 will be described with reference to FIG. 2.

FIG. 2 is a diagram illustrating an example of the operation of the PEs 10-1 to 10-3, and is a diagram for illustrating the communication method according to the present disclosure.

The PE 10-3 learns that EVIs to communicate through a control protocol (for example, BGP EVPN Route Type 1 as described in RFC 7432) and the like are set in the PE 10-1 and the PE 10-2, and that the identifiers of the PE 10-1 and the PE 10-2 and the same ESI are set in the PE 10-1 and the PE 10-2.

When a link between the PE 10-3 and the CE 3-3 is added/deleted, when a new CE 3 is connected/removed to/from the PE 10-3, when a new EVI is added/changed/deleted to/from the PE 10-3, or the like, the notification unit 11 of the PE 10-3 notifies the PEs 10-1 and 10-2 of the identifiers (for example, the IP address) of the PEs 10-1 and 10-2 and the Weight reference value of the PEs 10-1 and 10-2 held by the PE 10-3 (step S11).

In addition to the BGP, a plurality of protocols such as an interior gateway protocol (IGP) and a traffic engineering (TE) metric defined in RFC 7471.8570 can be used as a means for transmitting and receiving the identifier and the Weight reference value of the PE 10 between the PEs 10.

The selection list creation unit 12 of the PEs 10-1 and 10-2 creates a selection list including identifiers and Weight reference values of a plurality of PEs 10 (PEs 10-1 and 10-2) configuring the Multihoming based on the identifiers and Weight reference values of the PEs 10-1 and 10-2 notified of by the PE 10-3 (step S12).

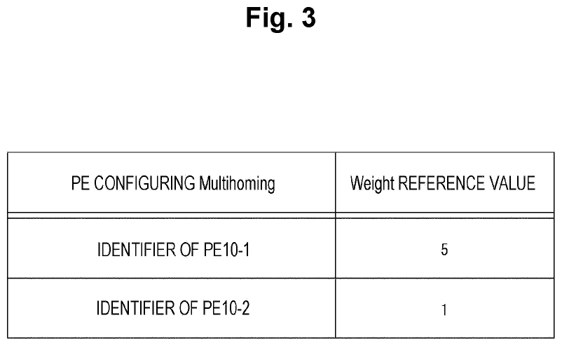

FIG. 3 is a diagram illustrating an example of a selection list created by the selection list creation unit 12.

As illustrated in FIG. 3, the selection list creation unit 12 creates, for each ES, a selection list in which identifiers of each of the plurality of PEs 10 configuring the Multihoming are associated with Weight reference values. In FIG. 3, the example in which the selection list is created for each ES has been described, but the present invention is not limited thereto. The selection list creation unit 12 may create the selection list for each set of ES and EVI, each set of ES and Ethernet tag, each set of ES, EVI and Ethernet tag, each set of ES, EVI and MAC address obtained from EVPN route-Type 2, or each set of ES, EVI, Ethernet tag and MAC address described in RFC 7432.

In addition, in a case where there is a plurality of Weight reference values based on a plurality of pieces of network information, the selection list creation unit 12 may calculate one Weight reference value by four arithmetic operations of the plurality of Weight reference values. In addition, the selection list creation unit 12 may calculate one Weight reference value by, for example, multiplying the inverse of the Weight reference value based on the second network information by the Weight reference value based on the first network information. In addition, the selection list creation unit 12 may calculate one Weight reference value from a function having the Weight reference value for each piece of network information as a variable.

The selection unit 13 selects the DF and the BDF from the selection list created by the selection list creation unit 12 based on a predetermined condition based on the Weight reference value (step S13). For example, the selection unit 13 selects the PE 10 having the smallest Weight reference value in the selection list as the DE, and selects the PE 10 having the second smallest Weight reference value as the BDF. In the example illustrated in FIG. 3, the selection unit 13 selects the PE 10-2 as the DF and selects the PE 10-1 as the BDF. The conditions for selecting the DF and the BDF are not limited to the example described above. For example, the selection unit 13 may select the PE 10 having the largest Weight reference value as the DF and select the PE 10 having the second largest Weight reference value as the BDF. In addition, the selection unit 13 may select the DF and the BDF, for example, by comparing magnitudes of values obtained by multiplying or dividing a value determined for each PE 10 in advance by the Weight reference value.

As described above, in the present embodiment, the PE 10-3 includes the notification unit 11. The notification unit 11 notifies each of the plurality of communication devices configuring the Multihoming of identifiers of the plurality of communication devices configuring the Multihoming and the Weight reference value according to a communication state of each of the plurality of communication devices configuring the Multihoming. In addition, the PEs 10-1 and 10-2 include the selection list creation unit 12 and the selection unit 13. Based on the identifiers of the plurality of communication devices configuring the Multihoming and the Weight reference value according to the communication state of each of the plurality of communication devices configuring the Multihoming notified of by another device, the selection list creation unit 12 creates a selection list including the identifiers and the Weight reference value of each of the plurality of communication devices configuring the Multihoming. The selection unit 13 selects the DF and the BDF from the created selection list based on a predetermined condition based on the Weight reference value.

By creating a selection list including Weight reference values corresponding to communication states of a plurality of communication devices (PEs 10-1 and 10-2) configuring the Multihoming and selecting the DF and the BDF from the created selection list base on a predetermined condition based on the Weight reference value, the DF and the BDF can be flexibly selected according to the communication state.

In FIG. 1, an example in which identifiers and Weight reference values of a plurality of PEs 10 (PE 10-1, PE 10-2) configuring the Multihoming are notified of by one PE 10 (PE 10-3) has been described, but the present disclosure is not limited thereto.

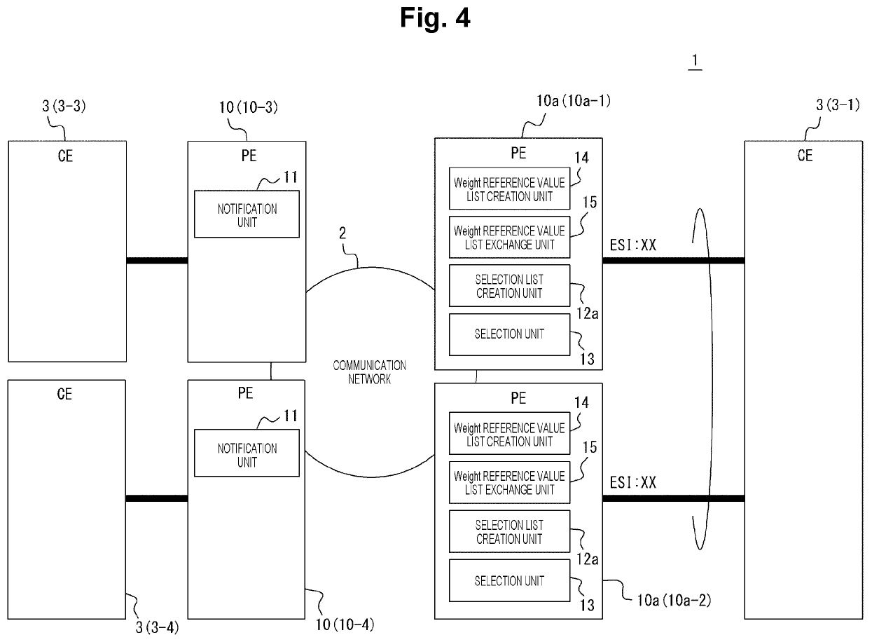

FIG. 4 is a diagram illustrating still another configuration example of the communication system 1 according to an embodiment of the present disclosure. In FIG. 4, configurations similar to those in FIG. 1 are denoted by the same reference signs, and description thereof will be omitted.

The communication system 1 illustrated in FIG. 4 includes a plurality of PEs 10a (10a-1 and 10a-2) and PEs 10 (10-3 and 10-4) connected to the communication network 2. The communication system 1 illustrated in FIG. 4 is different in that the PEs 10-1 and 10-2 are changed to PEs 10a-1 and 10a-2, and a PE 10-4 is added.

The PEs 10a-1 and 10a-2 are connected to one CE 3-1, and the same ESI: XX is set for the link between the PE 10a-1 and the CE 3-1 and the link between the PE 10a-2 and the CE 3-1. Therefore, the PEs 10a-1 and 10a-2 configure the Multihoming for the CE 3-1.

The PE 10-4 is connected to a CE 3-4. That is, the PE 10-4 is a communication device that is connected to the CE 3-4 different from the CE 3-1 and does not configure the Multihoming for the CE 3-1. In addition, the PE 10-4 is a communication device that is connected to a plurality of PEs 10a-1 and 10a-2 configuring the Multihoming for the CE 3-1 via the communication network 2 and does not configure the Multihoming. The configuration of the PE 10-4 is similar to the configuration of the PE 10-3. Similarly to the PE 10-3, the PE 10-4 notifies the PEs 10a-1 and 10a-2 of the identifiers and the Weight reference values of the PEs 10a-1 and 10a-2 configuring the Multihoming.

That is, in the communication system 1 illustrated in FIG. 4, the identifiers and the Weight reference values of the PEs 10a-1 and 10a-2 configuring the Multihoming are notified of by the PEs 10-3 and 10-4, which are a plurality of communication devices that are connected to the CEs 3-3 and 3-4 different from the CE 3-1 (one customer network device) and do not configure the Multihoming for the CE 3-1, to the PEs 10a-1 and 10a-2. The PEs 10a-1 and 10a-2 select the DF and the BDF based on the identifier and the Weight reference value notified of by the PEs 10-3 and 10-4.

Note that FIG. 4 illustrates an example in which the number of PEs 10a configuring the Multihoming is two for simplification of description, but the present invention is not limited thereto, and the number of PEs 10a configuring the Multihoming may be three or more. In addition, FIG. 4 illustrates an example in which there are two PEs 10 that do not configure the Multihoming, but the present invention is not limited thereto, and there may be three or more PEs 10 that do not configure the Multihoming. In addition, FIG. 4 illustrates an example in which one CE 3 is connected to the PEs 10 and 10a via the link, but the present invention is not limited thereto, and two or more CEs 3 may be connected to one PE 10 and one PE 10a.

Next, the configuration of the PE 10a-1 will be described.

As illustrated in FIG. 4, the PE 10a-1 includes a selection list creation unit 12a, the selection unit 13, a Weight reference value list creation unit 14, and a Weight reference value list exchange unit 15. The PE 10a-1 illustrated in FIG. 4 is different from the PE 10-1 illustrated in FIG. 1 in that the Weight reference value list creation unit 14 and the Weight reference value list exchange unit 15 are added that the selection list creation unit 12 is changed to the selection list creation unit 12a.

The Weight reference value list creation unit 14 creates a Weight reference value list including the identifier of each of the PEs 10-3 and 10-4 and the Weight reference value of the host device notified of by each of the PEs 10-3 and 10-4, based on the identifiers of the PEs 10a-1 and 10a-2 configuring the Multihoming and the Weight reference value notified of by each of the PEs 10-3 and 10-4. That is, the Weight reference value list creation unit 14 creates the Weight reference value list including the identifiers of the plurality of communication devices (PEs 10-3 and 10-4) that do not configure the Multihoming and the Weight reference values of the host devices notified of by the plurality of communication devices (PEs 10-3 and 10-4) that do not configure the Multihoming, based on the identifiers and the Weight reference values of the plurality of communication devices (PEs 10a-1 and 10a-2) that configure the Multihoming notified of by the plurality of communication devices (PEs 10-3 and 10-4) that do not configure the Multihoming.

The Weight reference value list exchange unit 15 exchanges the Weight reference value list created by the Weight reference value list creation unit 14 with a plurality of communication devices (other PEs 10a) configuring the Multihoming.

The selection list creation unit 12a creates the selection list based on the Weight reference value list created by the Weight reference value list creation unit 14 and the Weight reference value lists acquired from the plurality of communication devices configuring the Multihoming by the exchange by the Weight reference value list exchange unit 15.

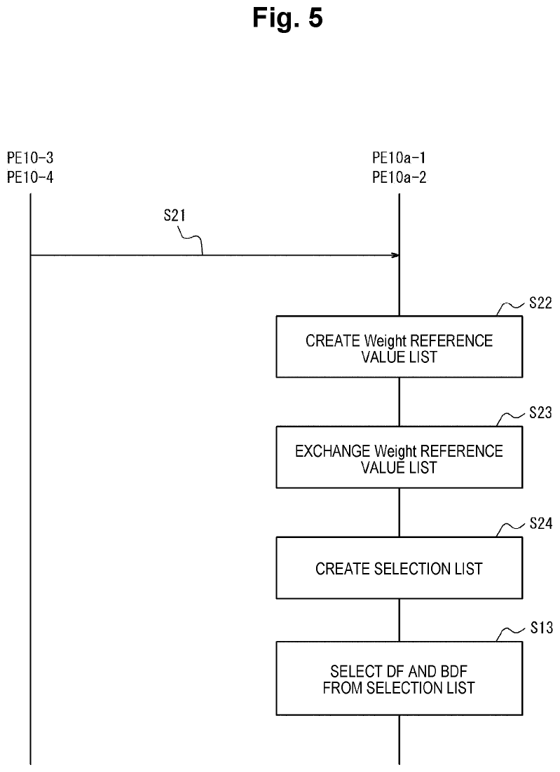

Next, operations of the PEs 10 and 10a illustrated in FIG. 4 will be described with reference to FIG. 5. In FIG. 5, processing similar to the processing in FIG. 2 is denoted by the same reference signs, and description thereof will be omitted.

The notification unit 11 of the PEs 10-3 and 10-4 notifies the PEs 10-1 and 10-2 of the identifiers 10 of the PEs 10-a and 10a-2 and the Weight reference values of the PEs 10a-1 and 10a-2 held by the host device when a link between the host device and the CE 3 is added/deleted, when a new CE 3 is connected/removed to/from the host device, when a new EVI is added/changed/deleted to/from the host device, or the like (step S21). Hereinafter, it is assumed that the notification unit 11 of the PE 10-3 notifies 5 as the Weight reference value of the PE 10a-1 and notifies 3 as the Weight reference value of the PE 10a-2. In addition, it is assumed that the notification unit 11 of the PE 10-4 notifies 1 as the Weight reference value of the PE 10a-1 and notifies 4 as the Weight reference value of the PE 10a-2.

The Weight reference value list creation unit 14 of each of the PEs 10a-1 and 10a-2 creates a Weight reference value list based on the identifiers and Weight reference values of the PEs 10a-1 and 10a-2 notified of by the PEs 10-3 and 10-4 (step S22).

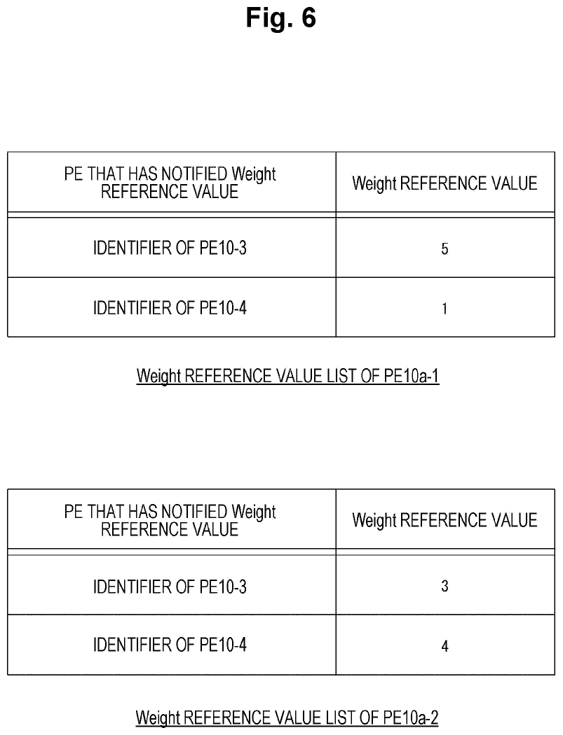

FIG. 6 is a diagram illustrating an example of a Weight reference value list created by the Weight reference value list creation unit 14.

As illustrated in FIG. 6, for each ES, the Weight reference value list creation unit 14 creates a Weight reference value list in which the identifiers of the PEs 10-3 and 10-4 that do not configure the Multihoming is associated with the Weight reference value of the host device notified of by each of the PEs 10-3 and 10-4. In FIG. 6, the Weight reference value list has been described as an example for each ES, but the present invention is not limited thereto. The Weight reference value list creation unit 14 may create a Weight reference value list for each set of ES and EVI, each set of ES and Ethernet tag, each set of ES, EVI and Ethernet tag, each set of ES, EVI and MAC address, or each set of ES, EVI, Ethernet tag and MAC address.

Referring back to FIG. 5, the Weight reference value list exchange unit 15 of the PEs 10a-1 and 10a-2 exchanges the Weight reference value list created by the Weight reference value list creation unit 14 among the plurality of PEs 10a configuring the Multihoming (step S23).

The selection list creation unit 12a of each of the PEs 10a-1 and 10a-2 creates a selection list including identifiers and Weight reference values of a plurality of PEs 10a configuring the Multihoming according to a predetermined condition based on the Weight reference value list of the host device created by the Weight reference value list creation unit 14 and the Weight reference value list of the other PEs 10a configuring the Multihoming acquired by the exchange by the Weight reference value list exchange unit 15 (step S24).

For example, the selection list creation unit 12a may create the selection list by using the Weight reference value of the Weight reference value list including the smallest (or largest) Weight reference value. In addition, the selection list creation unit 12a may create the selection list by using the Weight reference value of the Weight reference value list that does not include the smallest (or largest) Weight reference value. In addition, the selection list creation unit 12a may calculate an average value of the Weight reference values for each Weight reference value list, and create the selection list using the Weight reference value of the Weight reference value list having the smallest (or largest) calculated average value. In addition, the selection list creation unit 12a may calculate a sum, an average value, or the like of Weight reference values for each PE 10a configuring the Multihoming, and create a selection list including the calculated values as Weight reference values. Further, the selection list creation unit 12a may create the selection list using, as the Weight reference value, a value calculated based on a function using the Weight reference value of the Weight reference value list as a variable.

The creation of the selection list by the selection list creation unit 12a will be described using the Weight reference value list illustrated in FIG. 6 as an example. Hereinafter, a description will be given assuming that the selection list creation unit 12a creates a selection list including the Weight reference value of the Weight reference value list including the smallest Weight reference value as the Weight reference value of the PE 10a.

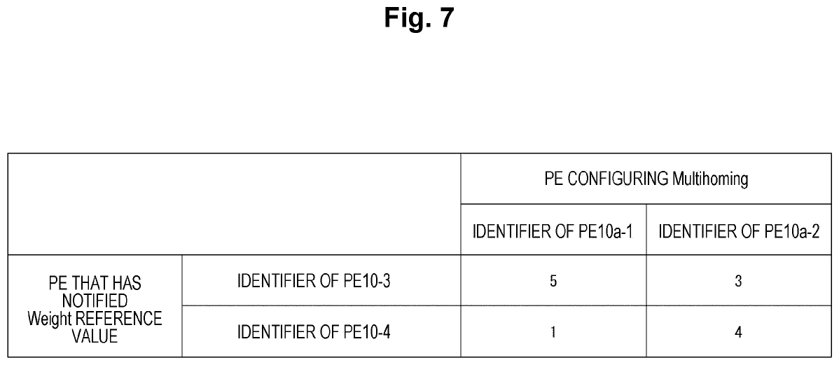

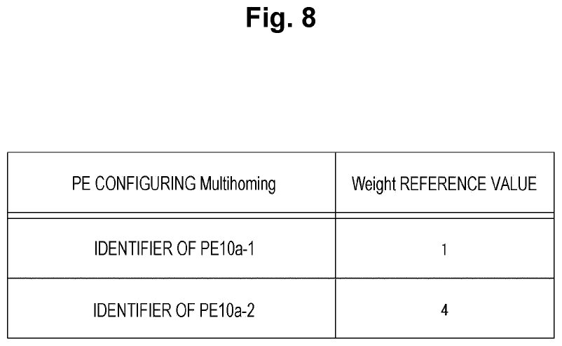

As illustrated in FIG. 7, the selection list creation unit 12a creates a matrix (Weight reference value matrix) in which the row is an identifier of the PE 10 to which the Weight reference value has been notified and the column is an identifier of the PE 10a configuring the Multihoming. The selection list creation unit 12a compares the respective Weight reference values included in the Weight reference value matrix, and specifies the smallest Weight reference value (“1” in the example illustrated in FIG. 7). The selection list creation unit 12a creates the selection list using the Weight reference value notified of by the PE 10-4 that has notified the specified smallest Weight reference value as it is. Therefore, as illustrated in FIG. 8, the selection list creation unit 12a creates a selection list using the Weight reference value notified of by the PE 10-4 as it is.

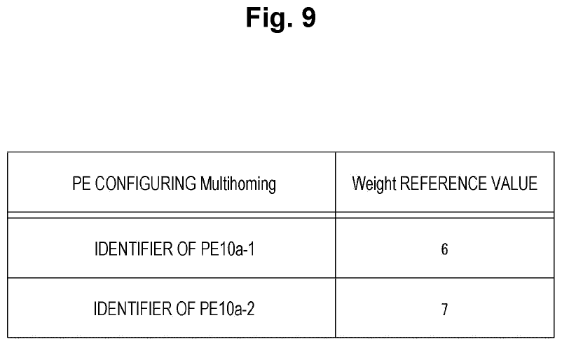

In addition, as described above, the selection list creation unit 12a may calculate a sum of Weight reference values for each PE 10a configuring the Multihoming, and create a selection list including the calculated values as Weight reference values. In this case, as illustrated in FIG. 9, for each of the PEs 10a-1 and 10a-2, the selection list creation unit 12a may create a selection list including a value obtained by summing the Weight reference values notified of by the PEs 10-3 and 10-4.

After the selection list creation unit 12a creates the selection list, the selection unit 13 selects the DE and the BDF from the selection list by the same processing as in FIG. 2.

In the communication system 1 illustrated in FIG. 4, the Weight reference value list is exchanged among the plurality of PEs 10a configuring the Multihoming to create the selection list. Therefore, even in a case where there is a plurality of PEs 10 that do not configure the Multihoming, the plurality of PEs 10a that configure the Multihoming can create a common selection list in each of the PEs 10a. Therefore, it is possible to prevent a discrepancy from occurring between the DF and the BDF selected between the PEs 10a.

In the communication system 1 illustrated in FIGS. 1 and 4, an example in which one or a plurality of PEs 10 that do not configure the Multihoming notify of identifiers and Weight reference values of PEs 10 and 10a that configure the Multihoming has been described, but the present disclosure is not limited thereto.

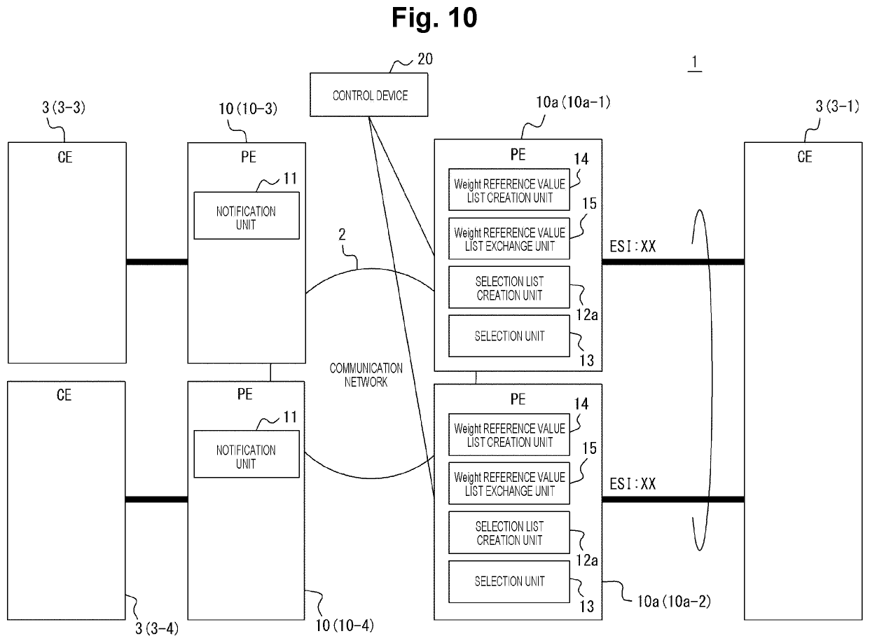

FIG. 10 is a diagram illustrating still another configuration example of a communication system 1 according to an embodiment of the present disclosure. In FIG. 10, components similar to those in FIG. 4 are denoted by the same reference signs, and description thereof will be omitted.

The communication system 1 illustrated in FIG. 10 includes a plurality of PEs 10a (10a-1 and 10a-2) and 10 (10-3 and 10-4) connected to the communication network 2, and a control device 20. The communication system 1 illustrated in FIG. 10 is different from the communication system 1 illustrated in FIG. 4 in that the control device 20 that manages the communication network 2 is added. Note that the control device 20 may be provided in the communication system 1 in which there is one PE 10 that does not configure the Multihoming as illustrated in FIG. 1.

The control device 20 is connected to PEs 10a-1 and 10a-2 configuring the Multihoming. The control device 20 may be directly connected to the PEs 10a-1 and 10a-2, or may be connected via the communication network 2. In FIG. 10, the control device 20 is connected to the PEs 10a-1 and 10a-2, but is not limited thereto, and may be connected to only one of the PE 10a-1 and the PE 10a-2. Furthermore, in FIG. 10, the control device 20 is connected to the two PEs 10a configuring the Multihoming, but is not limited thereto, and may be connected to three or more PEs 10a.

The control device 20 holds the Weight reference values of the PEs 10a-1 and 10a-2 configuring the Multihoming, and notifies at least one of the PE 10a-1 and the PE 10a-2 of the Weight reference values. The control device 20 acquires the Weight reference values of the PEs 10a-1 and 10a-2 based on, for example, the network information between the CE 3-3 and the CE 3-1 measured by the CE 3-3, the network information temporarily set by the communication carrier for maintenance of the PEs 10 and 10a, or the network information acquired by the control device 20 from the PEs 10-3 and 10-4 for the purpose of centralized management of the communication network 2.

Next, the operation of the PE 10a will be described.

The Weight reference value list creation unit 14 adds the identifier of the control device 20 and the Weight reference value of the host device notified of by the control device 20 to the Weight reference value list. In a case where the identifier and the Weight reference value notified of by the control device 20 are added to the Weight reference value list, the Weight reference value list creation unit 14 may add an identifier indicating that the set of the identifier and the Weight reference value is notified of by the control device 20 to the Weight reference value list.

The Weight reference value list exchange unit 15 exchanges the Weight reference value list created by the Weight reference value list creation unit 14 with other PEs 10a configuring the Multihoming.

The selection list creation unit 12a creates the selection list based on the Weight reference value list created by the Weight reference value list creation unit 14 and the Weight reference value list of the other PE 10a obtained by the exchange by the Weight reference value list exchange unit 15.

The selection unit 13 selects the DF and the BDF from the selection list created by the selection list creation unit 12. Here, in a case where the Weight reference value notified of by the control device 20 is included in the selection list, the selection unit 13 may select the DF and BDF based on the Weight reference value.

As illustrated in FIG. 10, by being notified of the identifier and the Weight reference value of the PE 10a configuring the Multihoming from the control device 20, network information outside the communication network 2 can be reflected in selection of the DF and the BDF, and the DF and the BDF can be temporarily changed when the communication carrier performs maintenance of the communication network 2.

Next, another configuration of the PE 10a configuring Multihoming and the PE 10 (PEs 10-3 and 10-4) not configuring the Multihoming will be described.

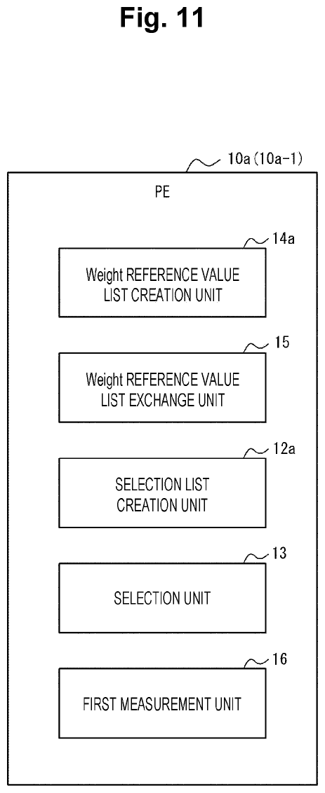

First, another configuration of the PE 10a-1 configuring the Multihoming will be described with reference to FIG. 11. In FIG. 11, the configuration of the PE 10a-1 will be described as an example, but the PE 10a-2 may have a similar configuration.

As illustrated in FIG. 11, the PE 10a-1 includes the selection list creation unit 12a, the selection unit 13, a Weight reference value list creation unit 14a, the Weight reference value list exchange unit 15, and a first measurement unit 16. The PE 10a-1 illustrated in FIG. 11 is different from the PE 10a-1 illustrated in FIGS. 4 and 10 in that the first measurement unit 16 is added and that the Weight reference value list creation unit 14 is changed to the Weight reference value list creation unit 14a.

The first measurement unit 16 measures network information between the host device and the CE 3 (CE 3-1) connected thereto.

The Weight reference value list creation unit 14a corrects the Weight reference value of the host device notified of by the PEs 10-3 and 10-4 based on the Weight reference value corresponding to the network information measured by the first measurement unit 16, and creates a Weight reference value list including the corrected Weight reference value. The Weight reference value list creation unit 14a corrects the notified Weight reference value by adding or subtracting the Weight reference value according to the network information measured by the first measurement unit 16 to or from the notified Weight reference value of the host device.

By measuring the network information of the host device and the CE3 connected thereto and correcting the Weight reference value notified of by another device based on the Weight reference value according to the measured network information, it is possible to flexibly follow the change in the End-to-End network information and select the DF and the BDF.

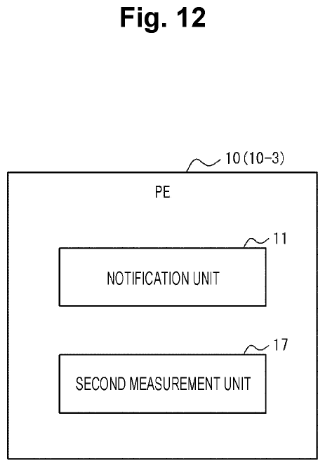

Next, another configuration of the PE 10 (PEs 10-3 and 10-4) that does not configure the Multihoming will be described with reference to FIG. 12. In FIG. 12, the configuration of the PE 10-3 will be described as an example, but the PE 10-4 may have a similar configuration.

As illustrated in FIG. 12, the PE 10-3 includes the notification unit 11 and a second measurement unit 17. The PE 10-3 illustrated in FIG. 12 is different from the PE 10-3 illustrated in FIGS. 1 and 4 in that the second measurement unit 17 is added. Hereinafter, the communication system 1 illustrated in FIG. 4 will be described as an example.

The second measurement unit 17 measures network information with each of the PEs 10a-1 and 10a-2 configuring the Multihoming connected via the communication network 2. For example, in a case of measuring the delay as the network information, the second measurement unit 17 measures the delay using Ping, Twanp, Ether-OAM (DM), or the like. In addition, for example, in a case of measuring a band as network information, the second measurement unit 17 measures the band using an interface counter or the like of the host device.

The notification unit 11 determines the Weight reference value of each of the PEs 10a-1 and 10a-2 based on the network information with each of the PEs 10a-1 and 10a-2 measured by the second measurement unit 17, and notifies the PEs 10a-1 and 10a-2 of the Weight reference value.

By measuring the network information with each of the PEs 10a-1 and 10a-2 and determining the Weight reference value of each of the PEs 10a-1 and 10a-2 based on the measured network information, it is possible to flexibly follow the change in the network information of the communication network 2 and select the DF and the BDF.

Note that the PEs 10-3 and 10-4 that do not configure the Multihoming may include the first measurement unit 16. For example, the PE 10-3 illustrated in FIG. 12 may further include the first measurement unit 16. In this case, the notification unit 11 may notify the PE 10 configuring the Multihoming of the Weight reference value based on the network information measured by the second measurement unit 17 and the Weight reference value based on the network information between the PE 10-3 and the CE 3-3 measured by the first measurement unit 16.

In the present embodiment, the configurations of the PEs 10 and 10a configuring the Multihoming and the PE 10 not configuring the Multihoming have been described separately, but the PEs 10 and 10a may configure the Multihoming and may not configure the Multihoming. Therefore, one PE 10 may include a configuration in a case of configuring the Multihoming and a configuration in a case of not configuring the Multihoming.

Next, a hardware configuration of the PE 10 according to the present disclosure will be described. Although the PE 10 will be described below as an example, the same applies to the PE 10a. Furthermore, as described above, the configuration of the PE 10 may be any of a configuration in a case of configuring the Multihoming, a configuration in a case of not configuring the Multihoming, and both a configuration in a case of configuring the Multihoming and a configuration in a case of not configuring the Multihoming.

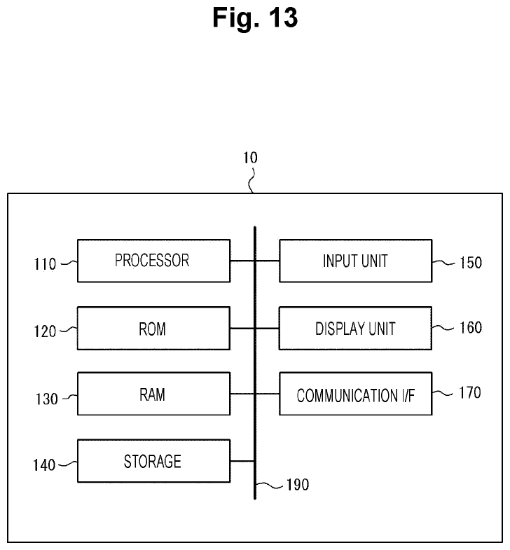

FIG. 13 is a diagram illustrating an example of a hardware configuration of the PE 10 according to the embodiment of the present disclosure. FIG. 13 illustrates an example of a hardware configuration of the PE 10 in a case where the PE 10 is configured by a computer capable of executing a program instruction. Here, the computer may be a general-purpose computer, a dedicated computer, a workstation, a personal computer (PC), an electronic note pad, or the like. The program instruction may be a program code, a code segment, or the like for executing required tasks.

As illustrated in FIG. 13, the PE 10 includes a processor 110, a read only memory (ROM) 120, a random access memory (RAM) 130, a storage 140, an input unit 150, a display unit 160, and a communication interface (I/F) 170. The components are communicably connected to each other via a bus 190. Specifically, the processor 110 is a central processing unit (CPU), a micro processing unit (MPU), a graphics processing unit (GPU), a digital signal processor (DSP), a system on a chip (SoC), or the like and may be configured by the same or different types of a plurality of processors.

The processor 110 is a controller that executes control of the components and various types of arithmetic processing. That is, the processor 110 reads a program from the ROM 120 or the storage 140 and executes the program using the RAM 130 as a working area. The processor 110 controls each configuration of the PE 10 described above and performs various arithmetic processing according to a program stored in the ROM 120 or the storage 140. In the present embodiment, the ROM 120 or the storage 140 stores a program for causing a computer to function as the PE 10 according to the present disclosure. By reading and executing the program by the processor 110, each configuration of the PEs 10 and 10a, that is, the notification unit 11, the selection list creation unit 12, the selection unit 13, the Weight reference value list creation unit 14, the Weight reference value list exchange unit 15, the first measurement unit 16, and the second measurement unit 17 is realized.

The program may be provided in a form in which the program is stored in a non-transitory storage medium, such as a compact disk read only memory (CD-ROM), a digital versatile disk read only memory (DVD-ROM), and a universal serial bus (USB) memory. The program may be downloaded from an external device via a network.

The ROM 120 stores various programs and various types of data. The RAM 130 as a work area temporarily stores programs or data. The storage 140 includes a hard disk drive (HDD) or a solid state drive (SSD) and stores various programs including an operating system and various types of data.

The input unit 150 includes a pointing device such as a mouse and a keyboard and is used to perform various inputs.

The display unit 160 is, for example, a liquid crystal display, and displays various types of information. A touch panel system may be adopted so that the display unit 160 can function as the input unit 150.

The communication interface 170 is an interface for communicating with other devices (other PEs 10 and 10a or the control device 20), and for example, standards such as Ethernet (registered trademark), FDDI, and Wi-Fi (registered trademark) are used.

A computer can be suitably used to function as each unit of the PEs 10 and 10a described above. Such a computer can be implemented by storing a program in which processing contents for implementing functions of units of the PEs 10 and 10a are described in a storage unit of the computer, and reading and executing the program by the processor 110 of the computer. That is, the program can cause the computer to function as the PEs 10 and 10a described above. In addition, the program can be recorded in a non-transitory recording medium. In addition, the program can also be provided via a network.

With regard to the above embodiments, the following supplementary items are further disclosed.

### (Supplementary Item 1)

A communication device that configures Multihoming in which a plurality of communication devices is connected to one customer network device and is connected to a communication network, the communication device including
a controller, in which
the controller creates a selection list including identifiers and Weight reference values of each of a plurality of communication devices configuring the Multihoming based on the identifiers of the plurality of communication devices configuring the Multihoming and the Weight reference value according to a communication state of each of the plurality of communication devices configuring the Multihoming notified of by another device, and
selects, from the created selection list, a designated forwarder (DF) that forwards traffic to the customer network device and a backup DF (BDF) that will become a new DF when a failure occurs in the DF, based on a predetermined condition based on the Weight reference value.

### (Supplementary Item 2)

The communication device according to Supplementary Item 1, in which
the another device is a communication device that is connected to a customer network device different from the one customer network device and does not configure the Multihoming for the one customer network device, or is a control device that manages the communication network.

### (Supplementary Item 3)

The communication device according to Supplementary Item 1, in which
the another device is a plurality of communication devices that is connected to a customer network device different from the one customer network device and does not configure the Multihoming for the one customer network device, and
the controller creates a Weight reference value list including identifiers of a plurality of communication devices not configuring the Multihoming and Weight reference values of a host device notified of the plurality of communication devices not configuring the Multihoming based on the identifiers and the Weight reference values of the plurality of communication devices configuring the Multihoming notified of by the plurality of communication devices not configuring the Multihoming,
exchanges the created Weight reference value list with a plurality of communication devices configuring the Multihoming, and
creates the selection list based on the created Weight reference value list and the Weight reference value list acquired from the plurality of communication devices configuring the Multihoming by the exchange.

### (Supplementary Item 4)

The communication device according to Supplementary Item 3, in which
the controller measures a communication state between the host device and a customer network device connected to the host device, and
creates the Weight reference value list including a Weight reference value obtained by correcting the Weight reference value notified of by the another device according to a result of the measurement.

### (Supplementary Item 5)

A communication device that is connected to a plurality of communication devices configuring Multihoming for one customer network device via a communication network and does not configure the Multihoming, the communication device including
a controller, in which
the controller notifies each of a plurality of communication devices configuring the Multihoming of identifiers of the plurality of communication devices configuring the Multihoming and a Weight reference value according to a communication state of each of the plurality of communication devices configuring the Multihoming.

### (Supplementary Item 6)

The communication device according to Supplementary Item 5, in which
the controller measures a communication state with each of a plurality of communication devices configuring the Multihoming, and
determines the Weight reference value based on a result of the measurement.

### (Supplementary Item 7)

A communication method by a communication device that configures Multihoming in which a plurality of communication devices is connected to one customer network device and is connected to a communication network, the communication method including
creating a selection list including identifiers and a Weight reference value of each of a plurality of communication devices configuring the Multihoming based on the identifiers of the plurality of communication devices configuring the Multihoming and the Weight reference value according to a communication state of each of the plurality of communication devices configuring the Multihoming notified of by another device, and
selecting, from the created selection list, a designated forwarder (DF) that forwards traffic to the customer network device and a backup DF (BDF) that will become a new DF when a failure occurs in the DF, based on a predetermined condition based on the Weight reference value.

### (Supplementary Item 8)

A non-transitory storage medium storing a program that is executable by a computer, the non-transitory storage medium storing a program causing the computer to function as the communication device according to Supplementary Item 1.

Although the above-described embodiments have been described as representative examples, it is apparent to those skilled in the art that many modifications and substitutions can be made within the spirit and scope of the present disclosure. Thus, it should not be understood that the present invention is limited by the above-described embodiments, and various modifications or changes can be made without departing from the scope of the claims. For example, a plurality of configuration blocks illustrated in the configuration diagrams of the embodiments can be combined into one, or one configuration block can be divided.

### REFERENCE SIGNS LIST

1 Communication system
2 Communication network
3 CE (customer network device)
10, 10a PE (communication device)
11 Notification unit
12, 12a Selection list creation unit
13 Selection unit
14 Weight reference value list creation unit
15 Weight reference value list exchange unit
16 First measurement unit
17 Second measurement unit
20 Control device
110 Processor
120 ROM
130 RAM
140 Storage
150 Input unit
160 Output unit
170 Communication I/F
190 Path

1. A communication device that configures Multihoming, the communication device comprising a processor configured to execute operations comprising:
creating a selection list, wherein the selection list includes an identifier of a communication device of a plurality of communication devices and a Weight reference value of the communication device of the plurality of communication devices, the plurality of communication devices configure Multihoming based at least on the identifier of the communication device of the plurality of communication devices and the Weight reference value of the communication device of the plurality of communication devices according to a communication state of the communication device of the plurality of communication devices based on a notification received by the communication device from another device, and the Multihoming includes the plurality of communication devices connected to one customer network device and further connected to a communication network; and
selecting, from the created selection list, a designated forwarder and a backup designated forwarder, wherein the designated forwarder forwards traffic to the customer network device, and the backup designated forwarder is to become a new designated forwarder when a failure occurs in the designated forwarder, based on a predetermined condition of the Weight reference value.

2. The communication device according to claim 1, wherein
said another device includes a communication device, the communication device connects to another customer network device, said another customer network device is distinct from any one customer network device of the plurality of customer network devices, and at least one of:
said another customer network device does not configure the Multihoming for any one customer network deice of the plurality of customer network devices, or
said another customer network device is a control device that manages the communication network.

3. The communication device according to claim 1, wherein
said another device includes a plurality of communication devices that is connected to a customer network device different from the one customer network device and does not configure the Multihoming for the one customer network device, and
said another device comprises a processor configured to execute operations comprising:
creating a Weight reference value list including identifiers of a plurality of communication devices not configuring the Multihoming and Weight reference values of a host device notified of a plurality of communication devices not configuring the Multihoming based on the identifiers and the Weight reference values of the plurality of communication devices configuring the Multihoming notified of by each of the plurality of communication devices not configuring the Multihoming, and
exchanging the created Weight reference value list with a plurality of communication devices configuring the Multihoming, and
the creating the selection list further comprises creating the selection list based on a Weight reference value list and a Weight reference value list acquired from a plurality of communication devices configuring the Multihoming.

4. The communication device according to claim 3, the processor further configured to execute operations comprising:
measuring a communication state between the host device and a customer network device connected to the host device, wherein
the Weight reference value list creation unit creates the Weight reference value list including a Weight reference value obtained by correcting the Weight reference value notified of by said another device according to a result of the measurement.

5. A communication device comprising a processor configured to execute operations comprising:
connecting to a plurality of communication devices configuring Multihoming for one customer network device via a communication network and does not configure the Multihoming;
notifying each of the plurality of communication devices configuring the Multihoming of identifiers of the plurality of communication devices configuring the Multihoming and a Weight reference value according to a communication state of each of the plurality of communication devices configuring the Multihoming.

6. The communication device according to claim 5, the processor further configured to execute operations comprising
measuring a communication state with each of a plurality of communication devices configuring the Multihoming, wherein
the notifying further comprises determining the Weight reference value based on a result of the measuring the communication state.

7. A communication method, comprising:
creating a selection list, wherein the selection list includes an identifier of a communication device of a plurality of communication devices and a Weight reference value of the communication device of the plurality of communication devices, the plurality of communication devices the Multihoming based at least on the identifier of the communication device of the plurality of communication devices and the Weight reference value of the communication device of the plurality of communication devices according to a communication state of the communication device of the plurality of communication devices based on a notification received by the communication device from another device, and the Multihoming includes the plurality of communication devices connected to one customer network device and further connected to a communication network; and
selecting, from the created selection list, a designated forwarder and a backup designated forwarder, wherein the designated forwarder forwards traffic to the customer network device, and the backup designated forwarder is to become a new designated forwarder when a failure occurs in the designated forwarder, based on a predetermined condition of the Weight reference value.

8. (canceled)

9. The communication device according to claim 1, wherein the plurality of communication devices includes a provider edge, and the Weight reference value indicates the network state of the provider edge.

10. The communication device according to claim 1, wherein the communication state includes at least one of:
a delay,
a band,
a number of hops in the communications network, or
a metric value of a routing protocol.

11. The communication method according to claim 7, wherein
said another device includes a communication device, the communication device connects to another customer network device, said another customer network device is distinct from any one customer network device of the plurality of customer network devices, and at least one of:
said another customer network device does not configure the Multihoming for any one customer network device of the plurality of customer network devices, or
said another customer network device is a control device that manages the communication network.

12. The communication method according to claim 7, wherein
said another device includes a plurality of communication devices that is connected to a customer network device different from the one customer network device and does not configure the Multihoming for the one customer network device, and
said another device comprises a processor configured to execute operations comprising:
creating a Weight reference value list including identifiers of a plurality of communication devices not configuring the Multihoming and Weight reference values of a host device notified of a plurality of communication devices not configuring the Multihoming based on the identifiers and the Weight reference values of the plurality of communication devices configuring the Multihoming notified of by each of the plurality of communication devices not configuring the Multihoming, and
exchanging the created Weight reference value list with a plurality of communication devices configuring the Multihoming, and
the creating the selection list further comprises creating the selection list based on a Weight reference value list and a Weight reference value list acquired from a plurality of communication devices configuring the Multihoming.

13. The communication method according to claim 12, further comprising:
measuring a communication state between the host device and a customer network device connected to the host device, wherein
the Weight reference value list creation unit creates the Weight reference value list including a Weight reference value obtained by correcting the Weight reference value notified of by said another device according to a result of the measurement.
